(19) United States
(12) Patent Application Publication
(10) Pub. No.: US 2009/0297746 A1
(43) Pub. Date: Dec. 3, 2009

(54) METHOD OF MANUFACTURING A BLOW MOULDED COMPONENT, BLOW MOULDED COMPONENT AND BLOW MOULD FOR MANUFACTURING A BLOW MOULDED COMPONENT

(76) Inventor: Takashi Sakaguchi, Mombris (DE)

Correspondence Address: SCHMEISER, OLSEN & WATTS, 22 CENTURY HILL DRIVE, SUITE 302, LATHAM, NY, 12110, US

(21) Appl. No.: 12/473,344

(22) Filed: May 28, 2009

(30) Foreign Application Priority Data
May 28, 2008 (DE) 102008025662.5-16

(51) Int. Cl. B32B 1/06; B29D 22/00

(52) U.S. Cl. 428/35.7; 264/572

(57) ABSTRACT

The invention relates to a method of manufacturing a blow moulded component, particularly a component for motor vehicle equipment, wherein a component wall and an interior cavity are formed in a mould by blow molding of a plastic blank, wherein a reinforcing element extending in the interior cavity is fixed in rigidifying manner, in that during the blow molding a fastening section of the reinforcing element is joined to the component wall interiorly of said wall at a junction, and a further fastening section of the reinforcing element is joined to the structural wall in the region of an opening of the component wall at a second junction. The invention also relates to a blow moulded component, particularly a component for motor vehicle equipment and a blow mould for manufacturing a blow moulded component from a plastic blank.

The invention relates to technologies in the area of blow moulding of a component consisting of a plastic material.

### BACKGROUND OF THE INVENTION

Blow moulding serves to manufacture a blow moulded component. In this process, in customary manner, a plastic blank, preferably in the form of a plastic tube, is inserted into an open mould. The mould is then closed and the blank is pressurized such that the heated plastic material is pressed against the contour of the interior of the mould in order to form the plastic body or the plastic component which after cooling can be removed from the mould. Blow moulding technology has the advantage that even complex structures can be fabricated relatively easily, particularly structures which if conventional plastic injection molding technology were used could not be removed from the mold.

A method of manufacturing a hollow body with an interior support framework with the use of blow moulding technology is known, e.g., from EP 0687546 A2. According to that method, a support frame is inserted in the tubular plastic blank prior to the blow moulding, which support frame is joined to wall regions of the finished hollow body after the blow moulding. The support frame increases the rigidity of the plastic body.

It is also known to integrate reinforcing elements into a blow moulded component after the blow moulding process; this requires a subsequent assembly step.

To increase the rigidity of plastic hollow bodies it is also known to generate ribbings of melted constituents of the tubular plastic blank in the interior of the blow moulded component. However, such elements often do not have adequate reinforcing properties. Therefore reinforcing cores are integrated additionally; however these increase the weight of the reinforcing elements or rigidifying elements. Further disadvantages are: limited choice of geometry of the reinforcing element generally made of round tube or rectangular tube, due to easy assembly; additional time needed for installation; non-uniform deformation caused by cooling makes additional shape correction measures necessary.

### BRIEF DESCRIPTION OF THE INVENTION

It is a task of the invention to create an improved, automatable technologies in the area of blow moulding, to manufacture a blow moulded component, which technologies facilitate the integration of reinforcing elements in blow moulded components.

This task is solved by a method of manufacturing a blow moulded component according to the independent claim 1, a blow moulded component according to the independent claim 13, and a blow mould according to the independent claim 23. Advantageous embodiments of the invention are set forth in the dependent subclaims.

According to the inventive concept, in manufacturing a blow moulded component, particularly a component for motor vehicle equipment, in a mould by blow moulding of a plastic blank, which blank is preferably in the form of a plastic tube so as to form a component wall and an interior cavity, wherein a reinforcing element extending in the interior cavity is fixed in a reinforcing manner, in that during the blow moulding a fastening section of the reinforcing element is joined to the component wall interiorly of said wall at a junction, and a further fastening section of the reinforcing element is joined to the structural wall in the region of an opening in the component wall at a further junction.

By means of this, plastic hollow bodies with any desired external contour can be manufactured. In particular, it may be provided that the component wall extends parallel in sections of opposite regions, such that an essentially constant distance between the wall sections is formed.

It is thus possible to manufacture a blow moulded component having high flexural rigidity, wherein any reinforcing elements can be integrated, which can be optimized regarding their-concrete design depending on the given application, e.g., with regard to the material and their shape. A blow moulded component is produced which is reinforced or rigidified, into which one or more reinforcing elements are integrated during the blow moulding. No subsequent processing steps are required. When the one or more reinforcing elements are integrated in the interior cavity, they are essentially invisible from the exterior. The reinforcing element may be arranged in any region of the interior cavity.

According to a preferred further development of the invention it is envisaged that the opening in the component wall is formed during the blow moulding by separation of the plastic blank at a separating element arranged on the reinforcing element. Thus the separating element on the reinforcing element itself creates the opening through which it then gets into the inner region of the plastic blank. The separating element may have one or more separating edges having, e.g., one or more cutting edges or teeth, to facilitate the separation of the plastic blank during the blow moulding. The separating element may be formed in the region of a projecting section of the reinforcing element. In a purposeful further development of the invention, an efficient separating element is formed by arranging the separating element in the region of an undercut of the reinforcing element.

According to a purposeful embodiment of the invention it can be envisaged that the plastic blank is seprarated during the blow moulding, by means of a separating element formed in the region of the fastening section.

According to an advantageous embodiment of the invention it is envisaged that in the course of separating the plastic blank, an adhering element is formed which remains on the reinforcing element, which adhering element will later be used to form the junction. The adhering element is a section of the plastic blank which is removed by the separating element during the blow forming, and which after separation remains on the reinforcing element. As the blow moulding process advances, the adhering element later serves to form the interior junction between the reinforcing element and the component wall. Thus, the adhering element is a piece of heated plastic which efficiently contributes to formation of the junction at the inner side of the component wall, when the plastic blank is pressed against the reinforcing element during blow moulding. Preferably the adhering element remains in the end region of the reinforcing element.

According to a preferred further development of the invention it is envisaged that the junction and the further junction are formed at opposite wall sections of the component.

According to an advantageous embodiment of the invention it can be envisaged that the junction and/or the further junction is/are formed with at least one undercut. By means of the at least one undercut, a kind of claw interaction between the reinforcing element and the component wall can be created.

According to a further development of the invention it can be envisaged that prior to the blow moulding, the reinforcing element is releasably mounted in an inner region of the mould. The reinforcing element can, e.g. be arranged at the inner wall of the mould. The reinforcing element is preferably borne in the region of the further fastening section. In a preferred embodiment, the reinforcing element is mounted on a mounting means, e.g. a pin. The reinforcing element projects into the interior of the mould. In an advantageous further development of the invention, the separating element is arranged in a moving surface over which the plastic blank passes during the blow moulding, thereby providing for efficient separation of the plastic blank during the blow moulding. The separating element with one or more cutting edges is preferably disposed such that a region of the plastic blank which region is to be separated comes to move directly towards the separating element during the blow moulding.

According to a preferred further development of the invention it is envisaged that in the course of the blow moulding, air is removed through venting elements of the mould in the region of the further junction which is created. In one embodiment, the venting elements are formed by means of bores or sintered metal regions in the wall of the mould. The ventilation promotes an optimal contact of the plastic blank with the inner wall of the mould and against the reinforcing element, in the region of the further junction.

According to a purposeful embodiment of the invention it may be envisaged that the junction and/or the further junction are in the form of a positive connection.

According to an advantageous embodiment of the invention it is envisaged that one junction joining is formed on a visible side of the component and the further junction is formed on an installation side of the component. The visible side of the component may be, e.g., a front side, whereas an installation side of the component, which is not visible after the installation of the blow moulded component in its intended application and thus may also be designated as the “mounting side”, forms a a rear side.

According to a preferred refinement of the invention, at least part of the external surface of the component is provided with a decorative material. In an advantageous refinement, the decorative material is inserted in the mould prior to the blow moulding. In this way, the bonding between the plastic material of the blow moulded component and the decorative material is accomplished during the blow moulding process. Alternatively, a decorative material may be applied to at least part of the blow moulded component after the blow moulding. The decorative material may be, e.g., a textile material.

According to an advantageous embodiment of the invention it can be envisaged that the reinforcing element is a structural element according to at least one design chosen from the following group of designs: a reinforcing element made of a plastically deformable material, a reinforcing element made of an aluminum profile, a reinforcing element with a profile having a double T cross section and a reinforcing element which extends two dimensionally in a surface of the component. The two dimensional reinforcing element may be, e.g., S-shaped,. The formation of a closed loop in the form of an ellipse, a circle or a quadrangle may also be provided.

In connection with the advantageous embodiments of the blow moulded component, corresponding described further developments of the method of manufacture of the component are applicable.

### DESCRIPTION OF PREFERRED EXEMPLARY EMBODIMENTS

The invention will be described in more detail hereinbelow using exemplary embodiments, with reference to the accompanying drawings, in which:

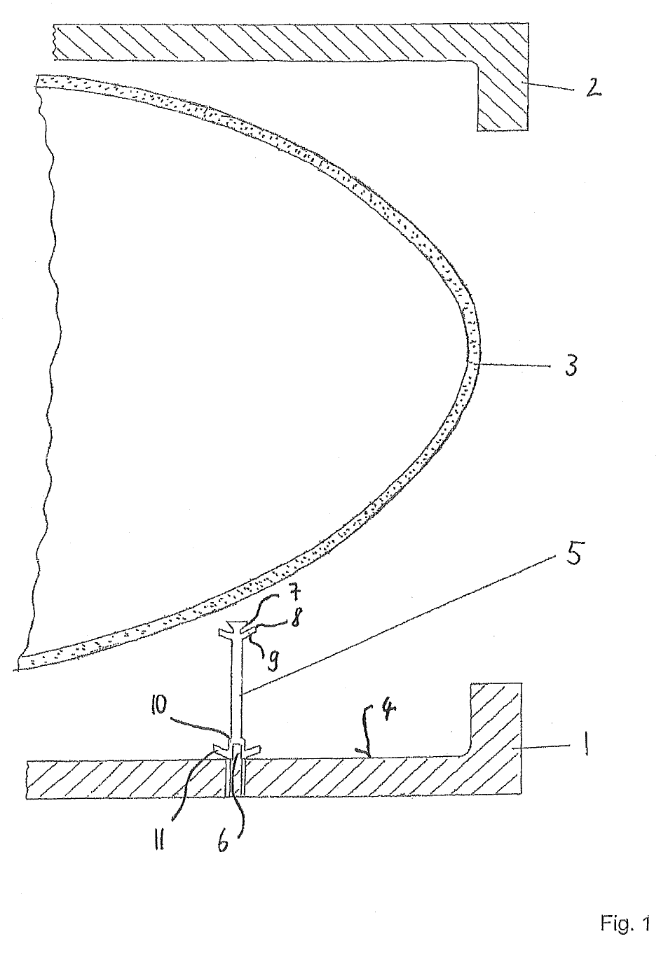

FIG. 1 is a schematic representation of a section of a blow mould wherein a reinforcing element is arranged at the inner wall;

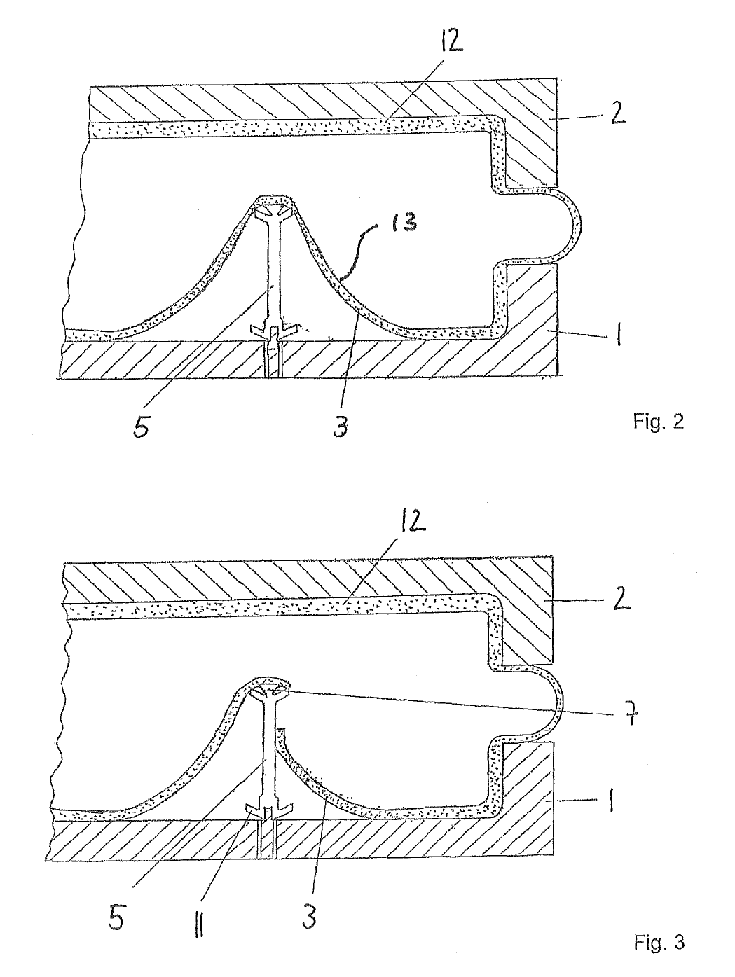

FIG. 2 is a schematic representation of the section of the blow mould of FIG. 1, in a partially closed state wherein a section of the moulded plastic piece has become disposed against the reinforcing element;

FIG. 3 is a schematic representation of the section of the blow mould of FIG. 1, wherein the plastic blank is severed on one side at the reinforcing element;

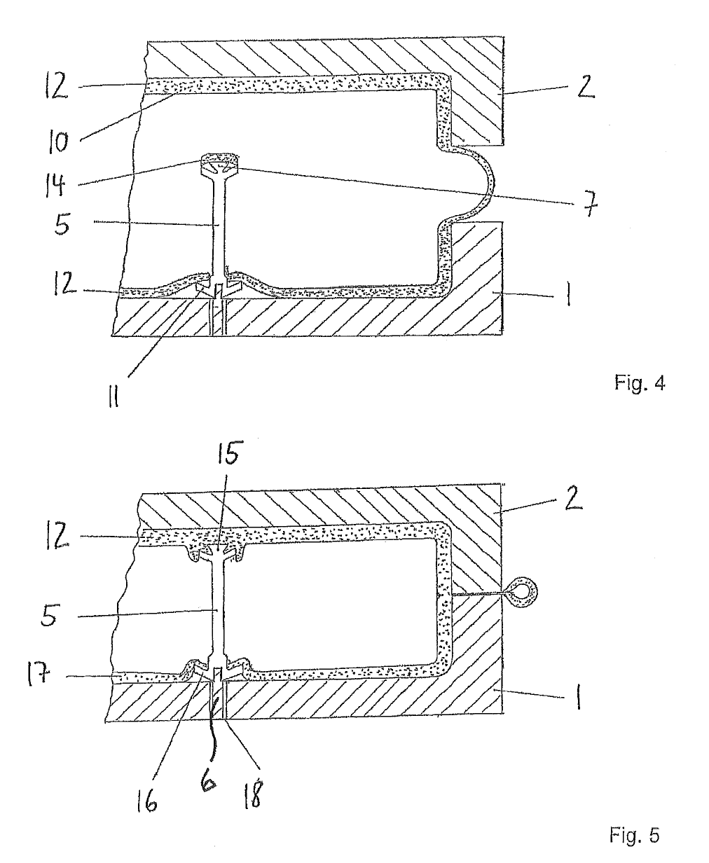

FIG. 4 is a schematic representation of the section of the blow mould of FIG. 1, wherein the plastic blank is severed on both sides at the reinforcing element;

FIG. 5 is a schematic representation of the section of the blow mould of FIG. 1, in a closed state, wherein the reinforcing element is connected to a component wall in the region of a junction and a further junction;

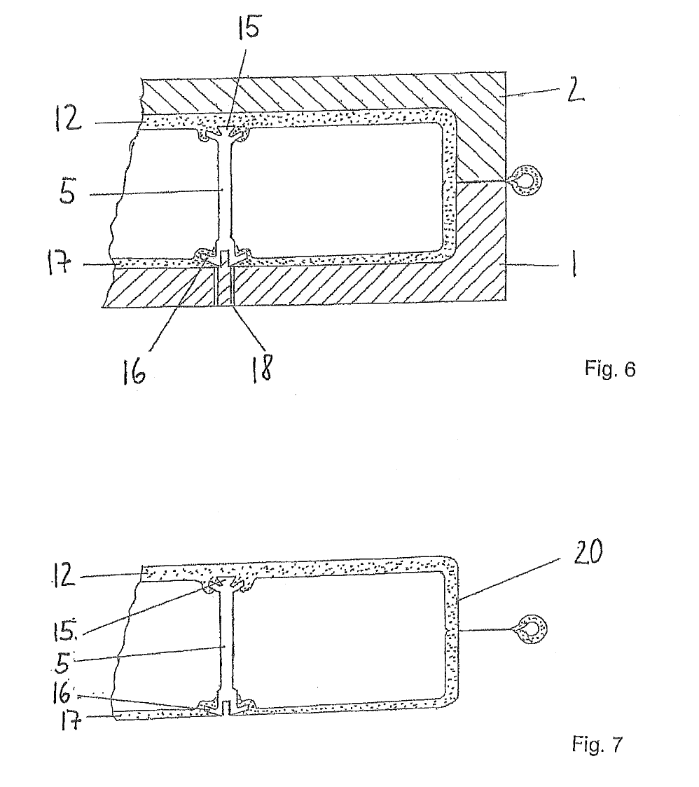

FIG. 6 is a schematic representation of the section of the blow mould of FIG. 1, in a closed state, wherein the formation of the junction and the further junction has been completed;

FIG. 7 is a schematic representation of a produced blow moulded piece after removal from the blow mould;

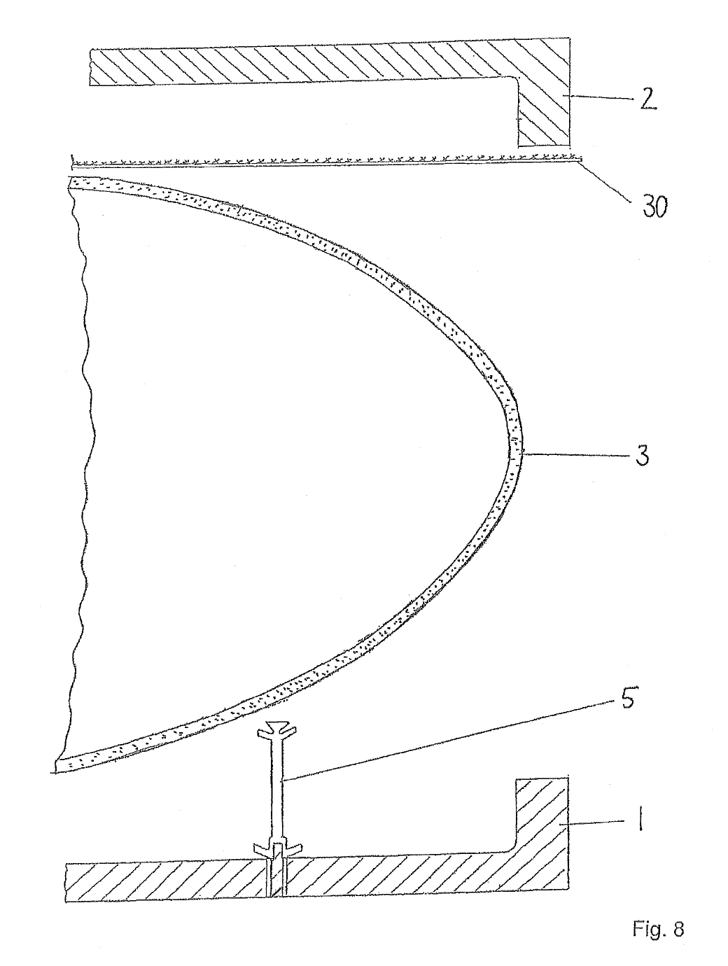

FIG. 8 is a schematic representation of the section of the blow mould, wherein in contrast to FIG. 1 an additional decorative material is also arranged in the region of the mould;

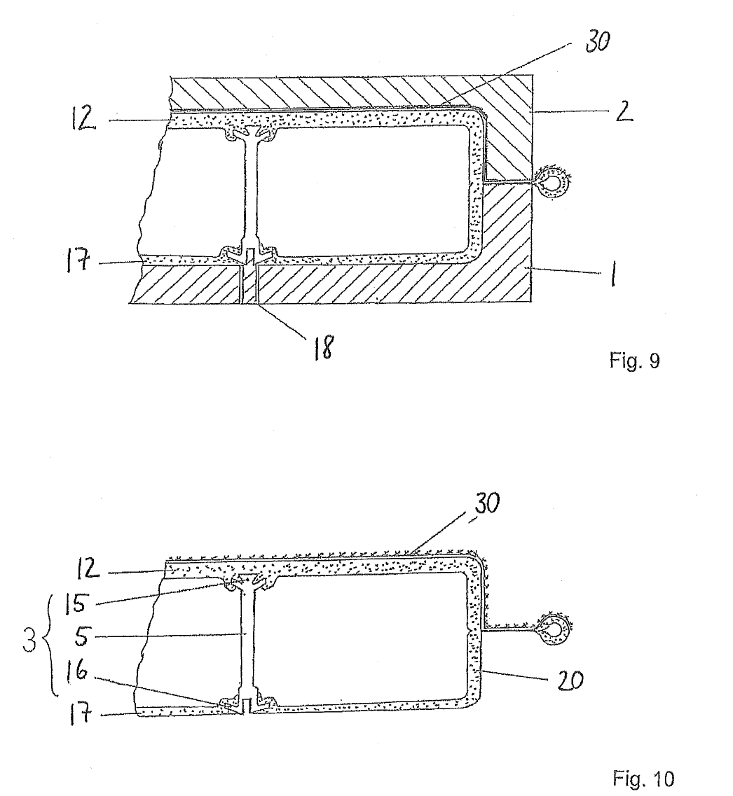

FIG. 9 is a schematic representation of the portion of the blow mould of FIG. 8, in a closed state; and

FIG. 10 is a schematic representation of a produced blow moulded piece with surface decoration after removal from the blow mould.

FIG. 1 illustrates schematically a section of a blow mould wherein a reinforcing element 5 is arranged at the inner wall.

A front and rear half of the blow mould 1, 2 are spaced apart from one another. A plastic blank 3 in the form of a heated plastic tube is arranged between the front and the rear half of the blow mould 1, 2. The reinforcing element 5 is releasably mounted on an inner side 4 of the front half of the blow mould 1, by means of a pin support 6. In the region of an end section 7 on the reinforcing element 5, separating edges 8 are formed on projections 9. Also, in the opposite end section 10 of the reinforcing element 5, projections 11 are provided which project from the inner side 4.

FIG. 2 illustrates schematically the section of the blow mould of FIG. 1, in a partially closed state, wherein a section 13 of the plastic blank 3 has become disposed against the reinforcing element 5. In the region of a front wall 12, the plastic blank 3 has made contact with the rear blow mould 2 of the blow mould.

FIG. 3 illustrates schematically the section of the blow mould of FIG. 1, wherein the plastic blank 3 has been severed on one side at the reinforcing element 5.

FIG. 4 illustrates schematically a section of the blow mould of FIG. 1, wherein the plastic blank 3 has been severed on both sides at the reinforcing element 5

An end section 7 of the reinforcing element 5 bears section 14 separated from the plastic blank 3, which is pressed against the rear side of the front wall 12 during the progress of the blow moulding according to FIG. 5, such that a junction 15 is created. According to FIG. 5, a further junction 16 is created on the opposite side, at which junction the reinforcing element 5 is connected to a rear wall 17. In the region junction 15 and the region of the further junction 16, the reinforcing element 5 and the material of the front wall 12 and rear wall 17 are connected in a positive manner.

FIG. 6 illustrates schematically a section of the blow mould of FIG. 1, in a closed state, wherein the formation of the junction 15 and the further junction 16 is completed.

According to FIG. 5, air vents 18 are formed in the region of the pin support 6 for ventilation, in order to promote the contact of the plastic blank 3 with the region of the further junction 16, so that ultimately connections between reinforcing element 5 and the front wall 12 and the rear wall 17 are created (cf. FIG. 7) in the blow moulded component 20 produced. FIG. 7 shows a section of the blow moulded component 20 after removal from the blow mould.

FIGS. 8 to 10 schematically illustrate a blow moulding process according to the manufacturing method described above, wherein part of the surface of the blow moulded component 20 are provided with a decorative material 30, which is inserted into the mould prior to the blow moulding process.

The features of the invention disclosed in the Description, Claims, and drawings may be significant individually or in any combination, for the realization of the invention in it different exemplary embodiment.

1. A method of manufacturing a blow moulded component (20), particularly a component for motor vehicle equipment, wherein a component wall and an interior cavity are formed in a mould (1, 2) by means blow molding of a plastic blank (3), wherein a reinforcing element (5) extending in the interior cavity is fixed in rigidifying manner, in that during the blow molding a fastening section (7) of the reinforcing element (5) is joined to the component wall interiorly at a junction (15) and a further fastening section (10) of the reinforcing element (5) is joined to the structural wall in the region of an opening in the component wall at a further junction (16).

2. The method according to claim 1, characterized in that the opening in the component wall is formed during the blow molding by separation the plastic blank (3) at a separating element (8, 9) arranged on the reinforcing element (5).

3. The method according to claim 2, characterized in that the plastic blank (3) is separated during the blow molding, by means of a separating element (8, 9) formed in the region of the fastening section (7).

4. The method according to claim 3, characterized in that, in the course of separating the plastic blank (3), an adhering element (14) is formed which remains on the reinforcing element (5), which adhering element will later be used to form the junction (15).

5. The method according to claim 1, characterized in that the junction (15) and the further junction (16) are formed at sections of the walls of the component which are opposed to one another.

6. The method according to claim 1, characterized in that the junction (15) and/or the further junction (16) are formed with at least one undercut.

7. The method according to claim 1, characterized in that, prior to the blow molding, the reinforcing element (5) is releasably mounted in an inner region of the mould.

8. The method according to claim 1, characterized in that, in the course of the blow molding, a ventilation is performed by venting elements (18) of the mould (1, 2) in the region of the further junction (16) which is formed.

9. The method according to claim 1, characterized in that the junction (15) and/or the further junction (16) is/are executed in the form of a positive connection.

10. The method according to claim 1, characterized in that the junction (15) is formed on a visible side of the component and the further junction (16) is formed on an installation side of the component.

11. The method according to claim 1, characterized in that an external surface of the component is at least sectionally provided with a decorative material (30).

12. The method according to claim 1, characterized in that the reinforcing element (5) is a structural element according to at least one design selected from the following group of designs: a reinforcing element made of a plastically deformable material, a reinforcing element made of an aluminum profile, a reinforcing element with a profile having a double T cross section and a reinforcing element which extends two dimensionally in a surface of the component.

13. A blow moulded component (20), particularly a component for motor vehicle equipment, having a component wall and an interior cavity formed from a plastic bland (3) by blow molding, wherein a reinforcing element (5) extending in the interior cavity is fixed in a rigidifying manner, in that a fastening section (7) of the reinforcing element (5) is joined to the component wall interiorly of said wall at a junction (15) formed in the blow molding process, and a second fastening section (10) of the reinforcing element (5) is joined to the structural wall in the region of an opening in the component wall at a further junction (16) formed in the blow molding process.

14. The component according to claim 13, characterized in that the reinforcing element (15) has a separating element (8, 9) which is configured so as to separate the plastic blank drung the blow molding, so as to form an opening therein.

15. The component according to claim 14, characterized in that the separating element (8, 9) is formed in the region of the fastening section (7).

16. The component according to claim 13, characterized in that a receiving section is formed on the reinforcing element (5), which section is configured so as to receive an adhering element (14) which remains on the reinforcing element (5) when the plastic blank (3) is separated.

17. The component according to claim 13, characterized in that the junction (15) and the further junction (16) are formed sections of the component wall, which are opposed to one another.

18. The component according to claim 13, characterized in that the junction (15) and/or the further junction (16) are formed with at least one undercut.

19. The component according to claim 13, characterized in that the junction (15) and/or the further junction (16) are executed in the form of a positive connection.

20. The component according to claim 13, characterized in that the junction (15) is formed on a visible side of the component and the further junction (16) is formed on an installation side of the component.

21. The component according to claim 13, characterized in that one external surface of the component is at least sectionally provided with a decorative material (30).

22. The component according to claim 13, characterized in that the reinforcing element (5) is a structural element of at least one design selected from the following group of designs: a reinforcing element made of a plastically deformable material, a reinforcing element made of an aluminum profile, a reinforcing element with a profile having a double T cross section and a reinforcing element which extends two dimensionally in a surface of the component.

23. A blow mould for manufacturing a blow moulded component from a plastic blank (3), wherein a reinforcing element (5) is releasably mounted in an interior of the mould, which reinforcing element is to be integrated into the blow moulded component in the course of the blow molding, which reinforcing element (5) has a separating element (8, 9) which severs the plastic blank during the blow molding.
